(19) United States
(12) Patent Application Publication
(10) Pub. No.: US 2001/0039462 A1
(43) Pub. Date: Nov. 8, 2001

(54) System and method for predicting software models using material-centric process instrumentation

(76) Inventors: Rafael Mendez, Chandler, AZ (US); Randy Smith, Clackamas, OR (US); Matthew Weldon, Phoenix, AZ (US); Adithya Mokshagundam, Phoenix, AZ (US); David G. Wasinger, Scottsdale, AZ (US)

Correspondence Address: SNELL & WILMER, L.L.P., One Arizona Center, 400 East Van Buren, Phoenix, AZ, 85004-0001, US

(21) Appl. No.: 09/824,110

(22) Filed: Apr. 2, 2001

Related U.S. Application Data
(60) Provisional application No. 60/194,237, filed on Apr. 3, 2000.

(51) Int. Cl. G05B 13/02

(52) U.S. Cl. 700/45

(57) ABSTRACT

A system and method for predicting software models used in chemical mechanical polishing (CMP) of workpieces using material-centric process instrumentation. One embodiment is a system which includes a feed forward loop for computing predictive calculations, a feed back loop for computing run-to-run calculations, a historical database which links together the feed forward and feed back loops, and a computational engine used to calculate new or adjusted CMP process parameters.

### CROSS-REFERENCE TO RELATED APPLICATIONS

This application claims the benefit of U.S. Provisional Application No. 60/194,237 filed Apr. 3, 2000, which is herein incorporated by reference.

### FIELD OF THE INVENTION

The present relates generally to a system and method for predicting software models using material-centric process instrumentation where a material is being processed and, more particularly, to a system and method for predicting software models in the chemical mechanical planarization of workpieces using material-centric process instrumentation.

### BACKGROUND OF THE INVENTION

Tools for chemical mechanical planarization (CMP) of workpieces are generally well known. Workpieces, which include but are not limited to, wafers, come in the form of a flat, substantially planar disk. Typical work pieces may include semiconductor wafers, magnetic disks, and optical disks. For many applications, particularly in the are of integrated circuits, the wafer serves as a high-tech building block. In order to produce quality microelectronic devices, it is critical that the wafer be manufactured uniform, planar, and devoid of any imperfections.

The manufacture of a semiconductor wafer generally includes a repetitious process of polishing and cleaning the wafer surface. The wafer may go through several material layering steps where one or more dielectrics or metals are “coated” on the wafer surface. After each layer is formed, it is often desirable to thoroughly clean, rinse, and dry the wafer to remove any debris from the surface. Any excess material on the wafer surface which may have accumulated during the layering step is polished off. Polishing the surface also planarizes the wafer. It is often a common practice to polish the wafer in two steps, first, a main polish followed by a buff polish. Of course, even the two step polish may be performed several times for a given wafer application.

Chemical mechanical planarization (“CMP”) machines or tools are widely known in the industry. The increasing demand for faster, more consistent wafer planarization has provoked a need for fully automated CMP machines. the automated CMP machine has the capability of performing all of the CMP processes within one enclosed structure under a set of commands. For example, the CMP machine may house the required software and hardware to route, polish, clean, and dry the wafer from start to finish.

The introduction of the automated CMP tool has significantly increased the speed and efficiency of processing wafers in the CMP industry, however, there are several drawbacks to the present CMP automation system. First, the methods to predict the correct polish parameters are not clearly defined and are not expanded to include the variations that are characteristic of a multi-head CMP tool. The current methods used to predict polish parameters are implemented at the manufacturing execution system (MES) level, computer integrated manufacturing (CIM) level, factory automation (FA) level, or process control framework level and the results are provided as the input to the tools. The system and method of the present invention remove some of the burden from the MES, CIM, FA or process control framework by calculating the results directly on the tool since much of the data relevant to the calculations already exists within the tool. This saves the time required to transfer the data to another source to calculate the process recipe parameters.

Second, the current methods for predicting polishing parameters do not typically allow for user control of the algorithms or data variables that are entered into the system in order to predict polishing parameters. Instead, software and hardware components are predesigned for specific tools, and specific software code is prewritten to process specific data in order to arrive at calculated polishing parameters.

Third, from the MES, CIM, FA or process control framework perspective, current methods for predicting CMP process parameters create a distributed control architecture by distributing data to the tool but do not allow any control by the tool. This requires more data transfer than would be necessary if control were allocated to the tool.

Accordingly, there exists a need for an improved system and method for predicting software models which decreases the amount of time for determining polishing process parameters thereby increasing throughput, provides for flexible configuration of software models for predicting polishing process parameters thereby decreasing cost of ownership, and provides for an increase in response of the MES, CIM, FA or process control framework to activities other than determining polishing process parameters.

### SUMMARY OF THE INVENTION

The present invention is directed to a predictive software model which allows for the calculation of process parameters for a specific tool directly on the tool itself. The predictive software model of the present invention is particularly useful for predicting polishing parameters for CMP systems in semiconductor fabrication facilities where the calculation of polishing process parameters on the polishing tool aid in increasing the effective yield by reducing the amount of material to be re-worked or over-polished.

One embodiment of the present invention is a system for predicting software models used in the CMP of workpieces which includes a feed forward loop for computing predictive calculations, a feed-back loop for computing run-to-run calculations, a historical database which links together the feed forward and feed-back loops, and a computational engine used to calculate new or adjusted CMP process parameters. The calculations from the feed forward and feed-back loops are advanced with reference to a material identification. In one aspect of this embodiment, the feed forward and feed-back loops each include a logic component and a trigger component where data values are passed in as input parameters to the logic component and are used with at least one mathematical algorithm to calculate polish process parameters in the computational engine which are then output from the trigger element.

The present invention also includes a method for automatically qualifying a CMP machine using a qualification rate for polishing workpieces which includes the steps of 1) loading the workpieces into the CMP machine, 2) determining whether the workpieces are a qualifying batch, 3) polishing the workpieces, 4) measuring the post CMP data of the workpieces, 5) calculating a qualification rate, 6) determining if the qualification rate is within predetermined limits, and 7) adjusting a qualification state of the CMP machine if the calculated qualification rate is within the predetermined limits. If the calculated qualification rate is not within the predetermined limits, the CMP machine is classified as unqualified and placed in an idle state until the CMP machine is returned to a qualified state. Another embodiment of the present invention includes a system for automatically qualifying a CMP tool using a qualification rate which includes means for carrying out the previously described method steps.

Still another embodiment of the present invention includes a method for automatically optimizing product characteristics in a CMP machine for advanced process control which includes storing run-to-run factors for a specific product/layer in a database while operating the CMP machine, obtaining a historical trend of the run-to-run factors after transmission of the product/layer from the database and sampling the trend to see of there is a skewing of the data, analyzing a magnitude of error, and calculating a product characterization factor for the product/layer if the pattern of error is consistently in the same magnitude and direction after the transmission of the product/layer.

Other embodiments and aspects of those embodiments are also included as part of the present invention and are later presented and described in detail in the detailed description of exemplary embodiments.

One advantage of the present invention is its ability to lessen the burden on the MES, CIM, FA, process control framework, or engineers by eliminating their need to estimate or calculate polish times for individual batches of workpieces. Instead, new polish times for a batch of workpieces can be computed by simply inputting a few parameters describing the characteristics of the batch and if process parameters change from what is expected prior to arriving at the CMP tool, the tool can calculate a new polish time based on the new input parameters without the need for external calculations.

Another improvement of the present invention over the prior art is that the system and method for predicting software models of the present invention for determining polishing process parameters has incorporated parameters that are unique to a multi-head polishing tool. These parameters characterizing a multi-head polishing tool adjust for the variations in polishing times.

Still another advantage of the predictive software model of the present invention is that it assumes a large part of the computational load necessary to predict polishing times for the CMP tool, especially in those cases where an MES, CIM, FA or process control framework are not automated or highly intelligent. The present invention also allows the tool to continue predicting polishing times if the MES, CIM, FA or process control framework becomes disconnected or unable to communicate. Accordingly, the function of predicting polishing time of the CMP tool does not suffer thereby increasing the availability of the tool.

The predictive software model of the present invention also possesses the advantage of enabling the user to define the predictive software model algorithms. In the present invention, the user is supplied with the capability of manipulating and adjusting calculations and polishing parameters to define different algorithms. As a result, multiple algorithms can be defined and applied to different product/layer combinations. Also, since varying levels of user knowledge exist in the CMP process, user-definable algorithms provide for the algorithm sophistication to grow with customer knowledge without the need for a supplier to continually rewrite program code.

Yet another advantage of the predictive software model of the present invention is its ability to accept user-defined factors and user defined parameters. These variables compensate for data that is not accounted for at the time the initial product is released. Parameters or factors that are valuable in modeling the polishing parameter recipes can be revealed as the understanding of the CMP process evolves. The ability of a user to add these factors eliminates the need for a supplier to re-write algorithms. Instead, the user simply attaches the new value to either a user definable factor or user definable parameter.

The above and other aspects of the present invention may be carried out in one form by a system for predicting software models to determine polishing process parameters in the CMP of workpieces which includes a feed forward loop for computing predictive calculations, a feed back loop for computing run-to-run calculations, a historical database linking the feed forward and feed back loops where the calculations from the loops are archived with reference to a material identification, and a computational engine to calculate new or adjusted CMP process parameters.

### BRIEF DESCRIPTION OF THE DRAWINGS

These and other features, aspects, and advantages of the present invention will become better understood with regard to the following description, appended claims, and accompanying drawings where:

FIG. 1a illustrates how polishing process parameters are predicted without using material-centric process instrumentation;

FIG. 1b illustrates how polishing process parameters are predicted with using material-centric process instrumentation in accordance with the present invention;

FIG. 2 illustrates the material-centric process instrumentation control loop and the predictive software model implementation of the present invention;

FIG. 3a shows a distributed database storage without the predictive software model implementation of the present invention;

FIG. 3b shows a distributed database storage with the predictive software model implementation of the present invention;

FIG. 4 illustrates a representation of how a tool qualification rate is determined in accordance with the present invention;

FIG. 5 is a flowchart showing automatic Qualification Rate determination in accordance with the present invention;

FIG. 6 illustrates a representation of a product characterization evaluation in accordance with the present invention;

FIG. 7 illustrates an example of a PCF optimization scenario showing an analysis of polish results of several groups of the same product/layer in accordance with the present invention;

FIG. 8 illustrates a calculated mean of several R2R factors following the polish of the first workpieces of the same product/layer to adjust the PCF using no weighting in accordance with the present invention;

FIG. 9 is a graphical illustration of the partial batch effect factor for a polishing tool having five carrier heads in accordance with the present invention;

FIG. 10 is a graphical illustration of a batch effect factor for a batch of workpieces in accordance with the present invention;

FIG. 11 illustrates various input parameters that are used to calculate process recipe parameters in accordance with the present invention;

FIG. 12 illustrates the sequential steps in data storage and correlation to predictive software model values in accordance with the present invention;

FIG. 13 illustrates an example of the sequential steps in calculating a new run-to-run factor with no weighting in accordance with the present invention;

FIG. 14 illustrates how data can be automatically retrieved with the knowledge of a product/layer in accordance with the present invention;

FIG. 15 illustrates the product/layer hierarchy contained in the product/layer hierarchy database contained within the predictive software model of the present invention;

FIG. 16 illustrates the link locations of the predictive software model predefined variables contained within the hierarchy levels in accordance with the present invention;

FIG. 17a depicts the various steps in loading a batch of workpieces into a CMP tool with load previous values disabled in accordance with the present invention;

FIG. 17b depicts the various steps in loading a batch of workpieces into a CMP tool with load previous values enabled in accordance with the present invention;

FIG. 18 is a flowchart showing the method for predicting software models to determine process polishing parameters in accordance with the present invention;

FIG. 19 is a graphical illustration of batch effect estimations in accordance with the present invention that are configurable by a user;

FIG. 20 illustrates mapping of tool parameters to user parameters in accordance with the present invention; and

FIG. 21 shows a block diagram of data paths and applications in accordance with the predictive software model of the present invention.

### DETAILED DESCRIPTION OF EXEMPLARY EMBODIMENTS

The present invention may be described herein in terms of functional block components and various processing steps. It should be appreciated that such functional blocks may be realized by any number of hardware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention. Further, it should be noted that the present invention may employ any number of conventional techniques for data transmission, signaling, data processing, network control, and the like. Such general techniques that may be known to those skilled in the art are not described in detail herein.

It should be appreciated that the particular implementations shown and described herein are illustrative of the invention and its best mode and are not intended to otherwise limit the scope of the present invention in any way. Indeed, for the sake of brevity, conventional signal processing, data transmission, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical communication system.

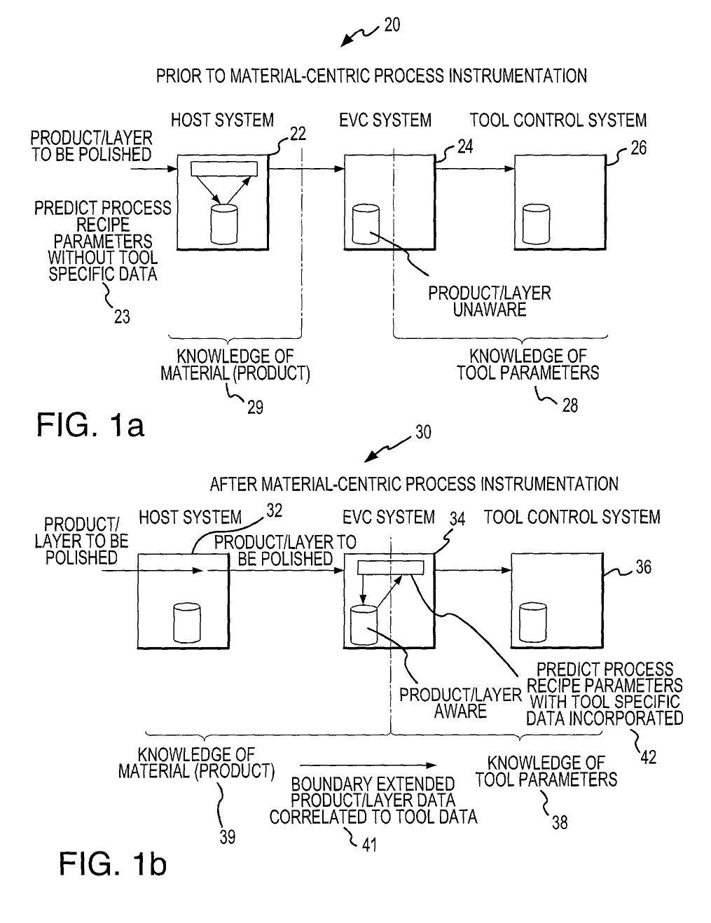

The predictive software model (PSM) of the present invention creates distributed control loops for material-centric process control (MPC). The concept involves distributing a control loop normally based on a MES, CIM system, FA system, or process control framework to the CMP tool. A computer for virtually controlling the equipment (EVC computer) is the central link where the association of a specific workpiece material is made to the CMP tool. As shown in the non material-centric process instrumentation system 20 depicted in FIG. 1a, the MES, CIM system, FA system, or process control framework, i.e. the host system 22, only knows about historical performance of a tool, not real time processing data of the tool; while the tool control system 24 and part of the EVC computer 26 only have knowledge of the tool's real-time processing data 28, and not data characteristics of workpiece materials 29. The non material-centric process instrumentation system predicts process recipe parameters without tool specific data 23 and then passes them onto the EVC computer 24 for assignment with specific tool parameters. In contrast, the material-centric process 30 depicted in FIG. 1b shows the host system 32 passing material specific workpiece data 39 to the EVC computer 34 which contains real-time tool processing data 38. This system allows for the material specific workpiece data 39 to be correlated with the real-time tool processing data 38 by extending data boundaries 41 in order to predict process recipe parameters with tool specific data 42 and then forwards the tool specific process recipe parameters to a tool control system 36. The material-centric process instrumentation system 30 provides enhanced processing parameter predictions by incorporating all data.

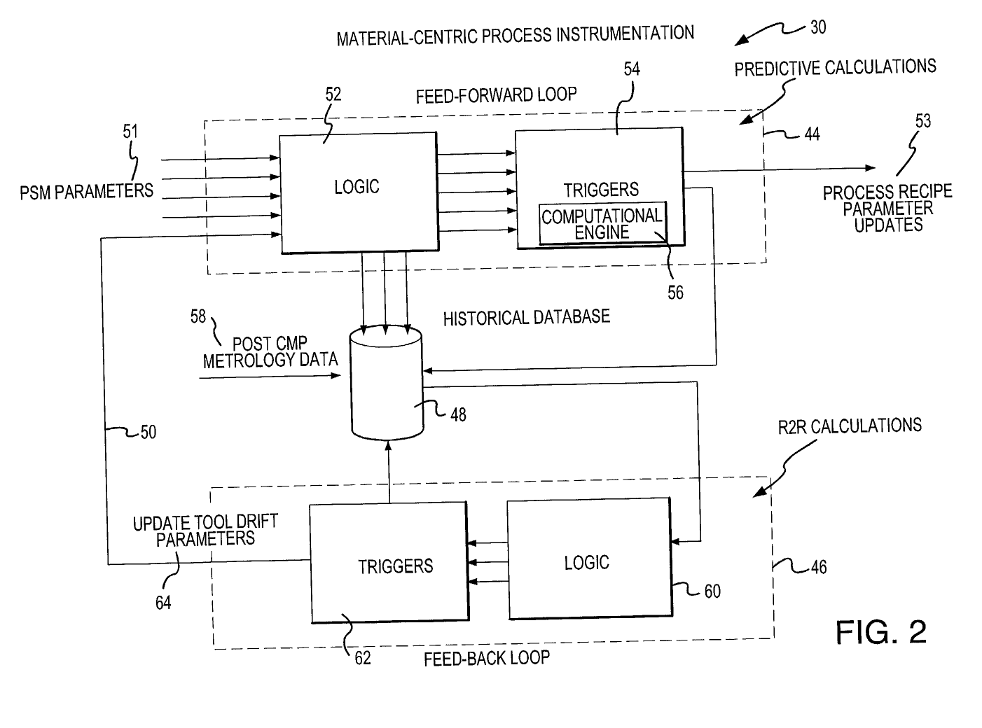

A detailed schematic of the predictive software model implementation of the material-centric process instrumentation (MPI) system is shown in FIG. 2. The MPI 30 includes the historical feed forward and feed back loops 44 and 46 which are linked by a historical database 48 where all information is archived with reference to a MES or CIM system material identification (MID). The PSM is a conceptual model of the MPI where predictive calculations represent the fast acting feed forward control loop 44 and the run-to-run (R2R) calculations represent the slower acting feed back control loop 46, with both calculations associating the data to archived MES or CIM material identification data. The combination of the two calculations creates the distributed process control loop 50.

In the PSM, data values are input as parameters 51 into the logic component 52 of the feed forward loop 44 and are used with a mathematical algorithm to dynamically calculate polishing process parameters 53 that are output at the trigger component 54 of the feed forward loop 44. A computational engine 56 is contained within the trigger component 54 of the feed forward loop 44 to calculate the actual polishing process parameters 53. Altering the process parameters will dynamically modify a set of baseline polishing recipes. In the present invention, the parameters 51 passed into the computational engine 56 are configurable and controllable by a user. The data variables 51 are capable of holding parameters for user defined factors and appear as new values to the PSM. Several parameters are available to pass tool related data to the PSM and these variables can have one of many tool values mapped to the parameter and input to the PSM. The values are then used in the calculations made in the computational engine 56 contained within the trigger component 54 of the feed forward loop 44. The MPI system allows for flexibility by giving complete control of the PSM parameters 51 (including algorithms) to the user.

Event driven asynchronous data collection and the archival of actual process parameters, material movement, and process state changes are tracked and archived within the historical database 48. The data in the historical database 48 can be used for future reference to assist in determining alarm conditions or to aid in automatically adjusting for process parameters that are slightly out of adjustment. Sets of PSM data are stored in the historical database 48. The sets of PSM values can be correlated to a workpiece specific product/layer combination, and retrieved as a set of data. Alterations of existing sets of database records and creation of new PSM sets of database records for either algorithms or workpiece specific product/layer combinations are tracked in a real-time tracking monitor (not shown). Any data alterations or creations trigger the requirement and recording of current user login name, date/time, and new versions to be updated to the version controlled database. Accordingly, accountability for any changes to the MPC databases can be determined.

As previously mentioned above, the MPI system of the PSM also includes a feed-back control loop 46. Post CMP data 58 can be input to the PSM and recorded in the historical database 48. The specific data written to database 48 is recorded as being related to either CIM or MES material identification. Input of the post CMP data triggers the activation of the slow reacting feed-back control loop 46 which updates a run-to-run parameter by calculating a run-to-run calculation in the logic component 60 of the feed back loop 46. Any adjustments in the run-to-run parameters are activated in the trigger component 62 of the feed back loop 46 which updates tool drift parameters 64. Tool drift parameters adjust for the natural drift in tool polishing characteristics which include, but are not limited to, removal rate, uniformity, slurry characteristics, and pad characteristics.

As shown above, the PSM acquires the data directly from the tool and passes the values to the computational engine. This process results in faster calculations which in turn results in increased throughput. In addition, data normally controlled within the tool can be exposed to the PSM as input parameters to be used in making calculations. These parameters would otherwise not be available to the MES, CIM system, FA system or process control framework. Furthermore, the ability in the PSM for the user to continuously create and modify algorithms enables more development at a more advanced pace without any dependence on software developers to create new algorithms.

The product/layer database implementation removes additional burden from the MES, CIM system, FA system or process control framework. The database which incorporates workpiece specific product/layer information could be independent for each tool, or a common database could be set up to span a group of tools in the factory and remove these databases from the MES, CIM system, FA system or process control framework. Moving the product/layer database implementation to the tool shortens the data transfer path thereby increasing throughput. Also, decreasing the amount of information that must be managed by the MES, CIM system, FA system or process control framework allows these systems to increase their response to other activities while decreasing the cost of ownership and the amount of time required to integrate the system into the factory.

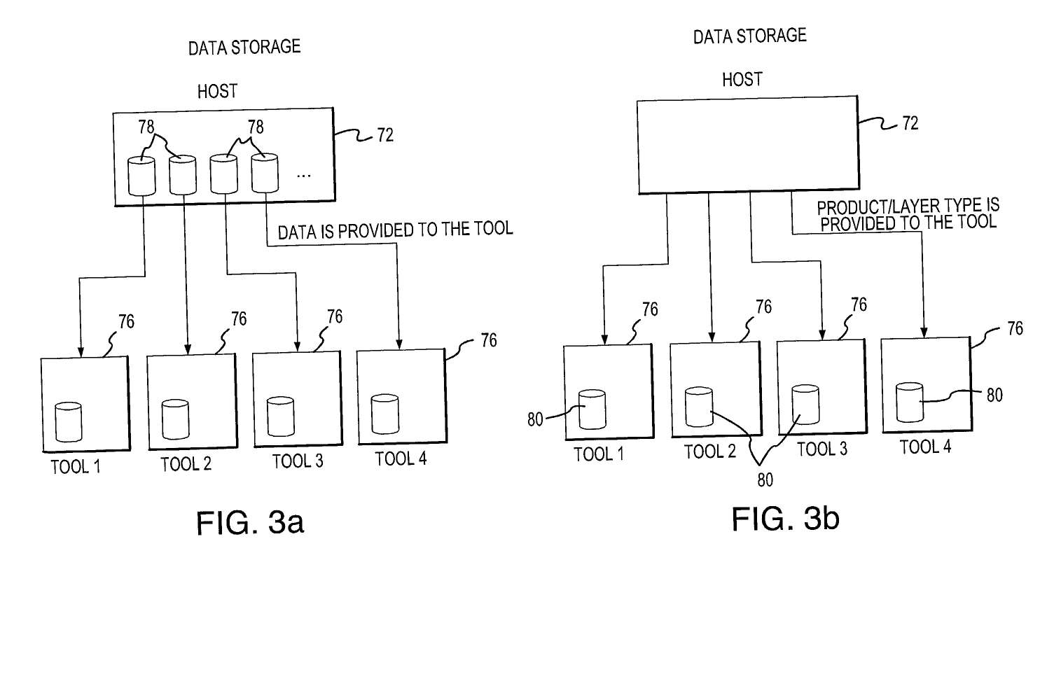

FIGS. 3a and 3b show a comparison of data movement to individual tools. The distribution of responsibility creates a distributed control architecture from the MES, CIM, FA or process control framework perspective. Without the PSM of the present invention as shown in FIG. 3a, the tool has no control from the MES, CIM system, FA system or process control framework perspective, i.e. host system 72 perspective, even though the tools 76 represent truly distributed control entities in that data is provided to the tools 76 from specific tool related databases 78 within the host system 72. In contrast, with the PSM of the present invention shown in FIG. 3b, data storage responsibility is removed from the host system 72 and product/layer type data is provided directly to the tools 76 and stored in tool databases 80 so that tools 76 now each take on the appearance of a true nested control loop in the larger control loop of the MES, CIM system, FA system, or process control framework.

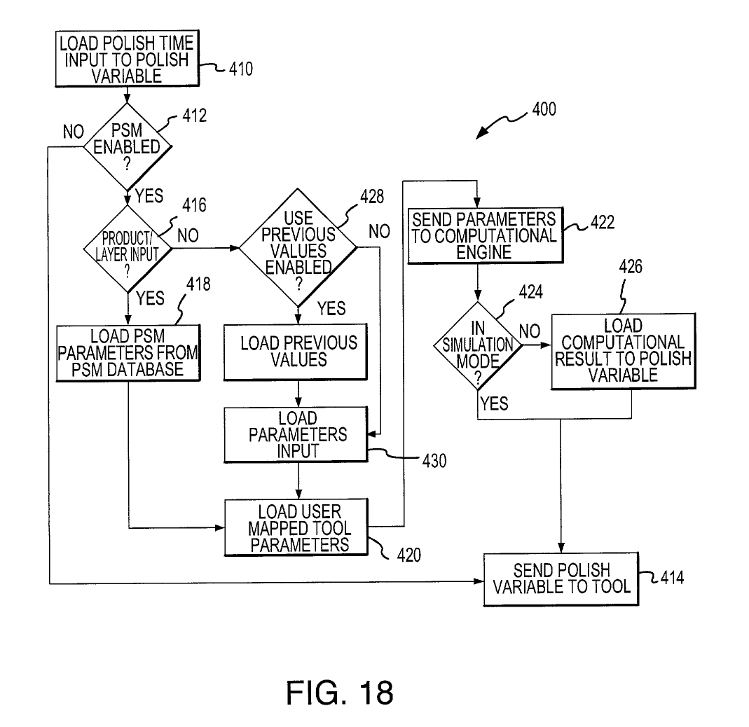

The PSM of the present invention accepts various parameters, passes the values to the computational engine, and returns one or more results as shown later with reference to FIG. 18. A list of predetermined parameters exists which can be sent as input parameters to the PSM. Several tool-related variables, which the user has the ability to selectively map into variables (discussed later with reference to FIG. 20), can also be sent to the computational engine. The ability to map the tool-related parameters into variables allows the user to add parameters to the PSM computations as the user desires. The functionality of the PSM provides for the computations to evolve as the CMP tool is characterized against varying tool parameters. The final parameter that is an input to the computational engine is an algorithm. The algorithm is either a mathematical expression (e.g., a+b+c), or the name of a compiled algorithm for use by a computing engine such as a compiled algorithm written in MATLAB.

The parameters are input into the mathematical expression to calculate a result. If a pre-written file is passed in as the parameter, the computational engine locates the file on the hard drive and passes the input parameters, from which the file returns one to several results. The results from the computational engine are used to adjust parameters that affect the CMP characteristics which include, but are not limited to, polish time(s), downforce adjustments, pad conditioning, slurry flows, and deionized water flows. Other parameters that can be adjusted in the pad condition process, carrier clean process, main polish process and final polish process include, but are not limited to, inner diameter (I.D.)/outer diameter (O.D.) values, table rotation speed, backfill pressures, bladder pressures, downforce, carrier rotation speed, and carrier orbiting speed (hereafter referred to as PSM outputs). The limit of parameter inputs and computed outputs are under the definition and control of the user.

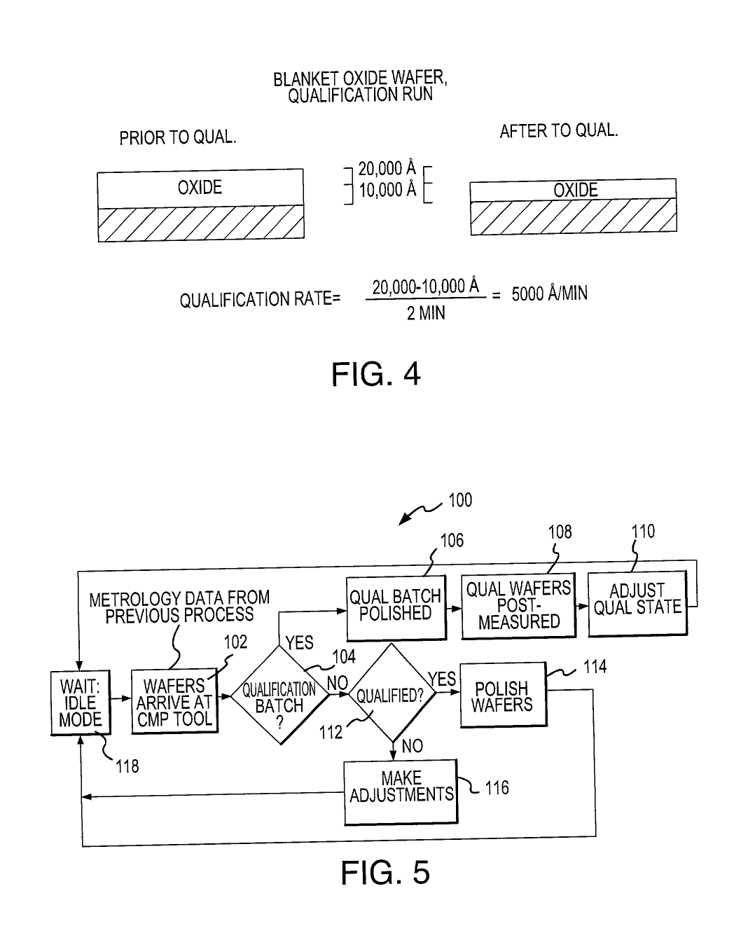

The PSM predicts the PSM outputs for the polish process for a single wafer or batch of wafers. The PSM outputs are based on various parameters. One parameter is the current tool Qualification Rate. The tool qualification is a common semiconductor procedure done periodically to determine the tool Qualification status. A value produced during a qualification is the Qualification Rate, or Qual Rate. The Qual Rate is the amount of material removal from a workpiece within a given time frame (i.e. Angstroms/minute). The Qualification batch is based on a blanket oxide wafer. An illustration of how the Qual Rate is determined is shown in FIG. 4. A blanket oxide wafer prior to material removal has an oxide layer with a thickness of 20,000 Angstroms. After polishing for 2 minutes, the resulting wafer has an oxide layer with a thickness of 10,000 Angstroms. The Qual Rate is the amount of material removed in a given time frame. Therefore, since 10,000 Angstroms of oxide material were removed from the oxide layer during the two minutes of polishing, the Qual Rate is 5000 Angstroms/minute.

Prior art methods for determining a tool's Qual Rate were often performed manually. More specifically, a batch of wafers referred to as a qualification batch would be polished to determine the state of the tool. The user would pre-measure a blanket oxide wafer, polish the wafers on the CMP tool and proceed to measure the post-CMP metrology data. The pre- and post-measured values would then be used to calculate a Qual Rate which would be used as the value to calculate process parameters.

The pre-measured values must be linked and stored to an MES, CIM, FA, or process control framework material identification. After completing the polishing cycle, the post-CMP data must be linked and stored to the same material identification as the pre-measurement data. The Qual Rate can then be calculated either manually by the user, or in more advanced facilities by the MES, CIM, FA or process control framework. The Qual Rate must be stored in a database along with its related material identification so that it can be correctly referenced when loading a new batch of wafers.

During the time period between taking pre-measurements and calculating the Qual Rate, the CMP tool remains idle. The idle period insures that no processing occurs that would invalidate the state of the tool which is determined by the qualification batch. The period of time during which the tool remains idle is variable and dependent on the user's speed in processing the qualification run through the various processes. The CMP tool's downtime is invaluable to a fabrication facility's production and decreasing the intervals available for processing leads to loss of revenue.

In order to overcome the shortcomings of the prior art, the PSM of the present invention provides for automatic Qual Rate calculation. The PSM software implements a data storage procedure to log all data and relate the data to either an MES or CIM material identification. The stored data includes incoming wafer thickness and post-CMP metrology data and is used to monitor and make adjustments to the PSM process (See FIG. 2). The automatic Qual Rate analysis monitors wafers entering the CMP tool and if the wafers are determined to be a qualification batch, the tool monitors the incoming and post-CMP data to calculate a new Qual Rate. The values for the incoming and post-CMP data can be extracted from the PSM database. If the Qual Rate is within user specified limits and the statistical limits of the tool processing are acceptable, the Qual Rate is updated in the tool's memory. The post-CMP metrology analysis can be performed by either a stand-alone metrology tool or by an integrated inline metrology tool. In either case, the data is stored in the PSM database (See FIG. 2). Using an integrated inline metrology tool would enhance the Qual Rate analysis. The post-CMP measurements would be performed in the CMP tool thereby removing the user interaction required to transfer the product to a stand-alone metrology tool. This process would increase the calculation speed and reliability of the qualification state evaluation.

A flowchart showing automatic Qual Rate determination 100 is shown in FIG. 5. A batch of wafers arrives at the CMP tool in step 102. Pre-measurement data is downloaded from the MES, CIM, FA or process control framework. The wafers are loaded into the CMP tool and a determination is made in step 104 as to whether the wafers comprise a qualification batch. If the wafers are flagged by the material identification as being a qualification batch in step 104, the CMP tool polishes the wafers in step 106 and then measures the wafers in step 108 after polishing to obtain post-CMP metrology data. The tool then evaluates the material removal rate and statistical process criteria to determine the new Qual state of the tool. The Qual state is then adjusted in step 110 and the tool would either become available or unavailable for processing by determining if the tool is qualified. If the wafers loaded into the CMP tool are not a qualification batch, a determination is made as to whether the tool is qualified in step 112. If the tool is qualified, the wafers are polished in step 114 and processing of the wafers continues. If the tool is not qualified in step 112, adjustments are made in step 116 to return the tool to a qualified state. Once the tool is qualified is step 112, the wafers are polished in step 114 and processing of the wafers continues. The CMP tool waits in an idle mode in step 118 until wafers arrive at the CMP tool in step 102 and are loaded into the tool.

The automatic Qual Rate calculation of the present invention aids in increasing the total wafer throughput by decreasing the time needed to complete the qualification state evaluation of a CMP tool. If the tool is not in a qualified state, the user and MES, CIM, FA or process control network are notified and if the tool is in a qualified state, the tool is immediately available to resume production. Further, if statistical limits are out of specification, then the tool can change to an unqualified state to reduce the chance of decreasing yield. The method of the present invention for automatically determining a Qual Rate lessens the burden on the MES, CIM, FA or process control framework by eliminating the need to maintain the qualification states of each individual CMP tool. The method of the present invention also removes the burden of maintaining predefined intervals at which the user is required to halt production in order to perform Qualification batches.

The first parameters used in the PSM calculations are the incoming and target thickness' of the upper film on workpieces. The incoming thickness is the actual upper film thickness of a workpiece upon entering the CMP tool while the target thickness is the desired upper film thickness of the workpiece after polishing. As previously described above, these thickness' are used to determine the Qual Rate of a CMP tool. However, the Qual Rate is based on a blanket oxide workpiece, and since the user will be polishing patterned production workpieces, other factors are used to provide a correlation between the differences in the polishing rates.

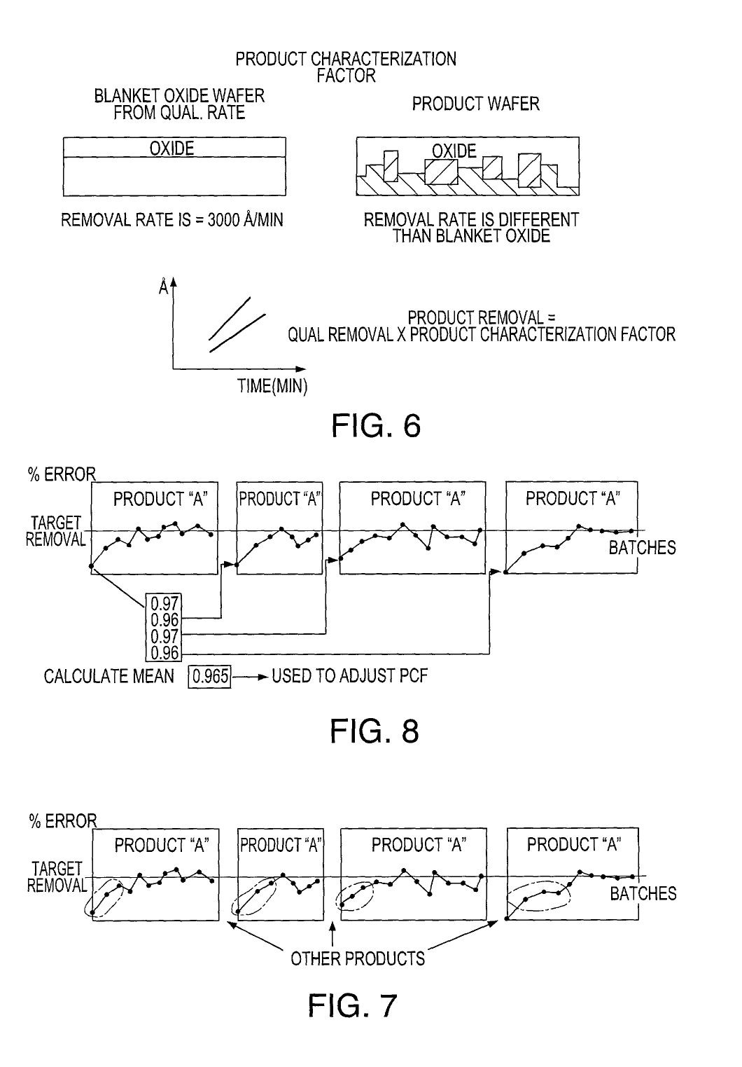

As previously stated, the PSM outputs (See FIG. 2) are based on various parameters. Another such parameter is the Product Characterization factor. Use of a Product Characterization factor is well known in the semiconductor industry. The Product Characterization factor (PCF) is a value that correlates the difference in polishing “Product A” versus polishing a blanket oxide workpiece. FIG. 6 represents the evaluation of a Product Characterization factor. The correlation of the difference in polishing product “A” versus polishing a blanket oxide workpiece has historically been seen as a scaling factor to adjust the Qual Rate. Therefore, the Product Characterization value is a real number multiplier.

The optimal performance of CMP polish parameter predictions uses the Qual Rate multiplied by the PCF to accurately predict the polish behavior of the CMP tool on a product/layer workpiece. If the PCF value is an accurate value, the transition from one product/layer to another would provide results no greater than those prior to the transition. If the current product/layer has predictions with a small percent error, a transition to another product/layer should not generate more than that percent error. Assuming that all parameters relating to tool behavior are kept consistent, the only factor changing is the PCF. If the transition leads to larger errors in predictions, the PCF is an incorrect value and needs adjustment.

PCF optimization queries the historical trend of run-to-run factors keying on the specific product/layers. The trend can be sampled to determine if there is a skewing of data. If the pattern of error compensation is consistently in the same magnitude and direction after switching product/layers, then a PCF optimization would occur. FIG. 7 illustrates an example of a PCF optimization scenario showing an analysis of polish results of several groups of the same product/layer, namely Product A. When the tool begins to polish Product A after having polished a different product, a consistent pattern is observed. The pattern shows the error being consistently on the same magnitude and on the negative side. The error is not required to be the same magnitude, but only large enough to insure that it is not noise in the signal.

The PCF compensation analyzes the magnitude of error and calculates a new recommended PCF for the product/layer that is evaluated. This value is then saved to the database (See FIG. 2). The change of the PCF triggers the logging of data to the equipment virtual controller. The data logged includes the user login name, the date and time, the previous and new values for the PCF, and the product/layer to which the PCF pertains. The parameter update also triggers a notification of the change in the PCF to the MES, CIM, FA or process control framework.

The automatic PCF optimization retrieves historical data from the PSM database (See FIG. 2) on a particular product/layer combination. The error in the removal rate is the key value. The optimization is performed by comparing the errors that occur after a transition from one product/layer to another. The trend of the run-to-run factor immediately after the product/layer transition is analyzed. As previously pointed out, if the value is consistently of the same magnitude and in the same direction, then a PCF optimization would occur. A weighted mean of several run-to-run values after a product/layer change are evaluated and the original PCF value is adjusted by one over the mean of the run-to-run (R2R) values. This results in the adjusted PCF. An example evaluation in predicting one polish parameter with the only factor used being the PCF is shown as follows:

Initial Prediction Formula: Post-CMP data R2R factor modification:

$${T}_{Pol} = \frac{( {T}_{Init} - {T}_{Tgt} )}{Q \times {F}_{R2R}} \times {F}_{PCF} {F}_{{R2R}^{′}} = \frac{( {I}_{Init} - {T}_{Meas} )}{Q \times {T}_{Pol}} \times {F}_{PCF}$$

Reinsert the new R2R factor back into the original formula to achieve the desired results. The optimum result would be that the R2R factor would continuously evaluate to 1, which would indicate the predicted values were accurate. The new equation with the R2R equal to 1 would evaluate as follows:

$${T}_{Pol} = \frac{( {T}_{Init} - {T}_{Tgt} )}{Q \times 1} \times \frac{{F}_{PCF}}{{F}_{{R2R}^{′}}}$$

where:

T_{Pol} is the Process Recipe Polish Time

T_{Init} is Initial Incoming Thickness

Tₘₑₐₛ is Actual Measured Final Thickness

Q is Qual Rate

F_{R2R} is the R2R Factor

F_{R2R}′ is the Adjusted R2R Factor

F_{PCF} is Product Characterization Factor

From this example it can be seen that the new PCF would be:

$${F}_{{PCF}^{′}} = \frac{{F}_{PCF}}{{F}_{{R2R}^{′}}}$$

where F_{PCF}′ is the adjusted PCF. This example shows how the R2R factor is used to adjust the previous PCF. Although the example uses one R2R factor, the actual optimization would use the weighted mean of several R2R factors. A calculated mean of several R2R factors to adjust the PCF using no weighting is shown in FIG. 8. A historical tracking would be monitored to determine the PCF optimization to minimize compensating for noise and variations due to other influences.

In the PSM of the present invention, batches of wafers are continuously polished on the CMP tool without regard to the initial calculation of PCF values. In accordance with the present invention, the PSM predicts polish parameters as shown with reference to FIG. 2 and the automatic PCF optimization is periodically triggered. The historical database (See FIG. 2) is queried for a trend in R2R factors for a particular product/layer and an analysis of the R2R factors renders an adjusted PCF to compensate for inaccuracies in previous PCF calculations. The PCF evaluation is performed in the background with no noticeable effects to the user.

In the prior art, manual operations are currently used for determining a PCF. Several batches of wafers of a specific product/layer combination are polished to determine the polish rate. The polish rate of the product/layer combination is then referenced to a previously determined Qual Rate. A scaling factor is then determined in comparing the product/layer workpiece to the oxide workpiece which becomes the PCF for the product/layer. This method requires the repeating of this sequence to arrive at a new PCF. One drawback in evaluating the PCF with this method is the need to polish several batches of product workpieces to evaluate the PCF. Further, to minimize the variations in the PCF due to other parameters, the tool would have to be run where all polish process parameters are held constant. This would put the product workpieces at risk of being improperly polished and could require the workpieces to be re-worked. The CMP tool would also be unavailable for production during this evaluation period.

In contrast, the automatic PCF optimization of the present invention allows the CMP tool to run while continuously monitoring and optimizing the PCF values automatically. Unlike the prior art methods, multiple similar product/layer types would not be required for consecutive processing and the optimizing sequence would retrieve all the similar product/layer types in sequence, regardless of processing relation to other product/layers. Further, the CMP tool would not be required to be out of production during the optimization process.

The automatic PCF optimization of the present invention aids in increasing the total wafer throughput by decreasing the amount of error in calculating process parameters due to incorrect values of the PCF for a product/layer. The cost of ownership would also be reduced with the automatic PCF optimization of the present invention by alleviating the MES, CIM, FA or process control framework from scheduling downtime to perform PCF optimizations. Calculations of the new PCF values would be routinely performed by the tool thereby decreasing the interaction of the MES, CIM, FA, process control framework, or user. Moreover, more precise CMP polishes would occur, especially on transitions of product/layer combinations thereby increasing yield and reducing re-works.

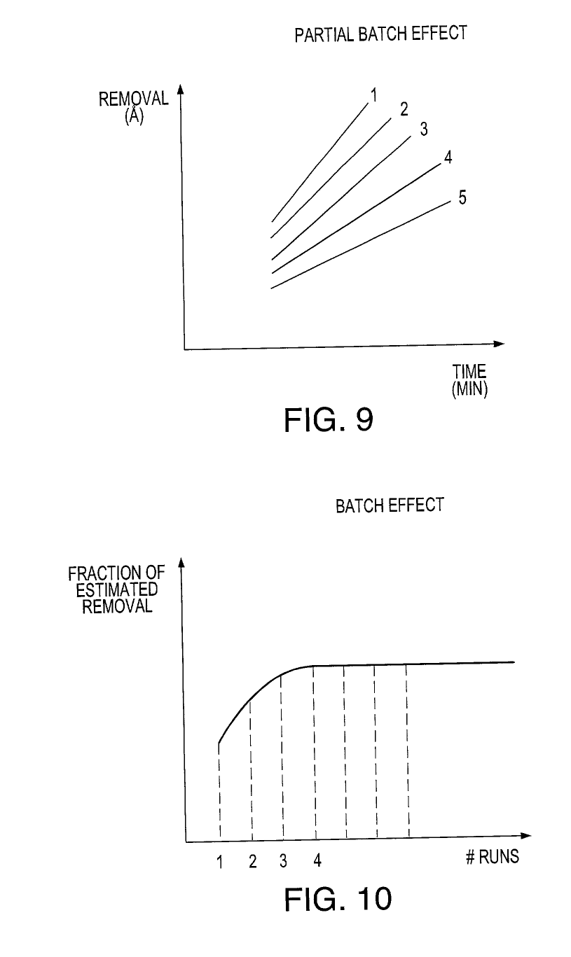

Another parameter for a PSM input is the partial batch effect factor (PBEF). In those CMP tools having multiple carrier setups, small variations occur in the polish process from one carrier to another if partial workpiece loads are polished on the tool. This orientation is characterized in the PSM by the PBEF, an example of which is shown in FIG. 9. The BPEF shifts the polishing rate for the entire set of carriers and shifts the removal rate differently based on the number of carriers in use for each batch of wafers.

Another PSM input parameter, namely the batch effect factor (BEF), is a value that shifts the removal rate for a batch of wafers to adjust for the tool idle periods. Tool idle periods affect the tool removal rates and the rates differ due to the thermal effects of the carriers. The BEF allows the removal rate to be shifted by a factor as shown in FIG. 10.

The PSM input variables include both user defined factors and user defined parameters. User factors differ from user parameters in that user parameters are linked to a value that is being maintained and monitored by the tool directly. Accordingly, the user maps the user parameters to a tool variable while the user factors are monitored and provided by the user. The user defined factors and parameters allow the user to supply user defined variables to the PSM calculations. This feature enables expansion capabilities that do not require additional modifications by the vendor. If the user determines that a tool characteristic or material identification characteristic can be integrated into the PSM to provide more precise calculations than a previous computation, the user can utilize a user defined variable as the transport mechanism. The cost of implementing new variables is eliminated and the ability to test new variables is inherently built into the design. Accordingly, the user defined variables provide a convenient method to research characterizing various parameters in a PSM computation.

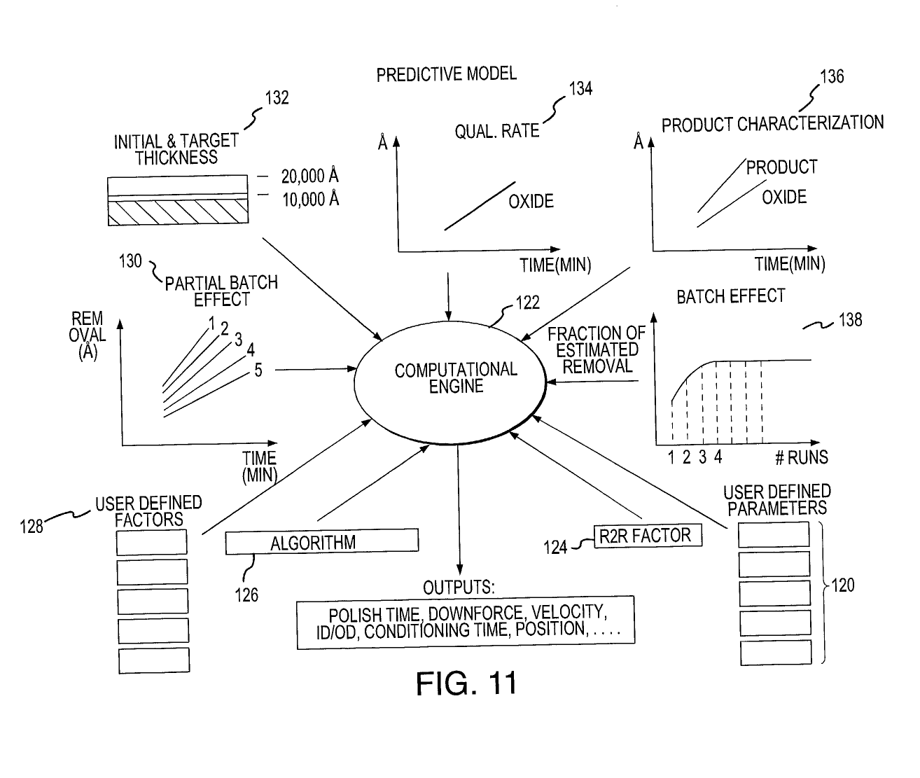

All of the PSM parameters and factors are passed to the computational engine to determine the process recipe parameters for each batch of workpieces. The resulting process recipe parameters are calculated using an algorithm chosen by the user. FIG. 11 shows a sample of the inputs used in the PSM to predict the recipe parameters. One of the user defined parameters 120 for a batch of wafers is a specific product/layer combination. This parameter will automatically define what parameters will be passed to the computational engine 122. A database (See FIG. 2) stores and links parameters. The main key associating the data is the specific product/layer combination. Other inputs used in the PSM to predict process recipe parameters include, but are not limited to, R2R factors 124, algorithms 126, user defined factors 128, partial batch effect 130, initial and target thickness' 132, Qual Rate 134, Product characterization factor 136, and batch effect 138.

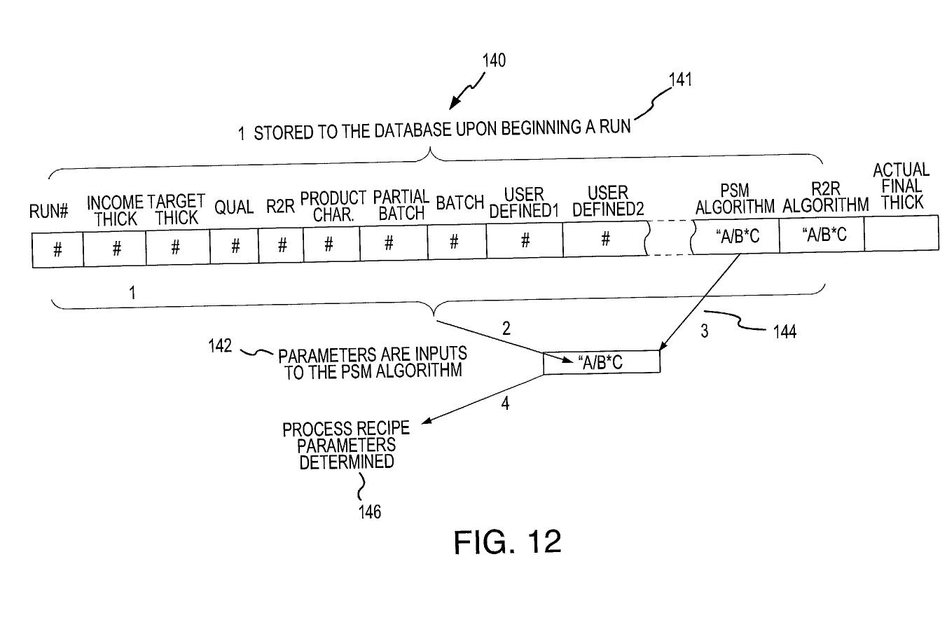

Once a batch of workpieces is run, the PSM parameters and results are stored within the historical database shown in FIG. 2. The historical database normally stores many of the parameters associated with the workpieces contained within the batch and the PSM variables are added to the database and linked to the batch. This allows for later access and evaluation of the PSM with actual wafer thickness. FIG. 12 shows the sequential steps 140 for data storage and correlation to PSM values. PSM parameters and results are stored to the database in step 141. PSM parameters, which may include user define parameters, are input to the computational engine in step 142 and the PSM algorithm is input to the computational engine in step 144. Finally, the computational engine determines the process recipe parameters in step 146.

The user also has the ability to input post-CMP metrology data into the PSM. This data is added to the historical database (See FIG. 2) and linked with the batch to which the data corresponds. The PSM then compares the predicted performance to the actual performance and adjusts the R2R parameter. The R2R parameter then adjusts the PSM to compensate for the natural drift in CMP performance. This feedback parameter helps maintain stability in the process. A weighted mean of several R2R values is taken prior to adjusting the actual R2R factor to avoid compensating for noise.

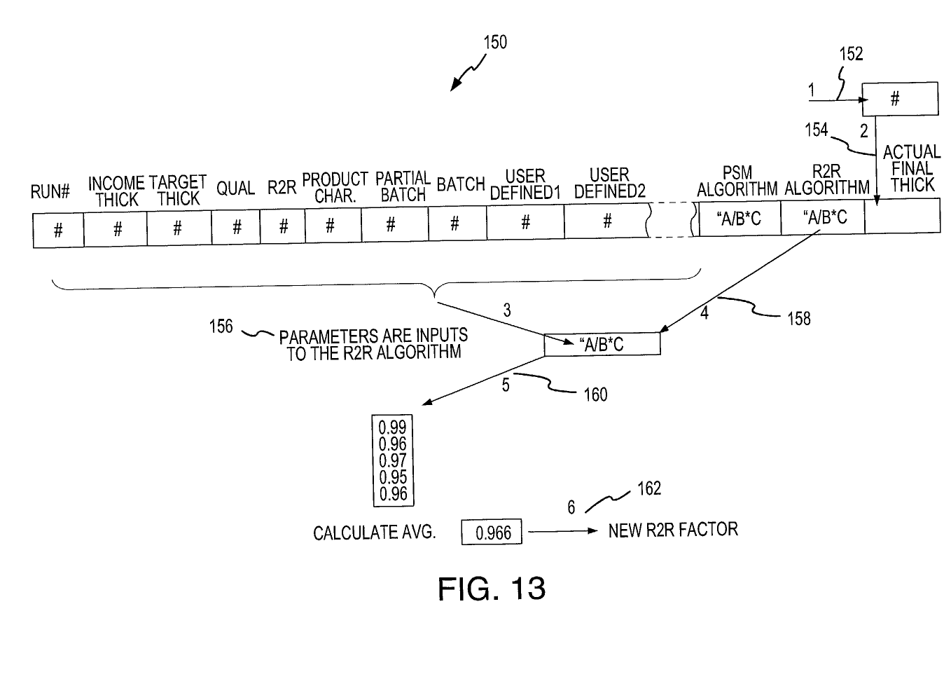

FIG. 13 illustrates the sequence 150 for updating an R2R factor. First, in step 152, post-CMP data is input into the PSM and these values are stored in the database in step 154. Next, the stored parameters and R2R algorithm are input into the computational engine in steps 156 and 158. Next, a new R2R factor is calculated in step 160 and finally the last several R2R factors are used to calculate a weighted mean in step 162 to arrive at the new tool R2R factor. Post-CMP data is directly input to the database with the implementation of integrated inline metrology into the tool. The feedback has shorter intervals between the data being measured and collected and their archival to the database.

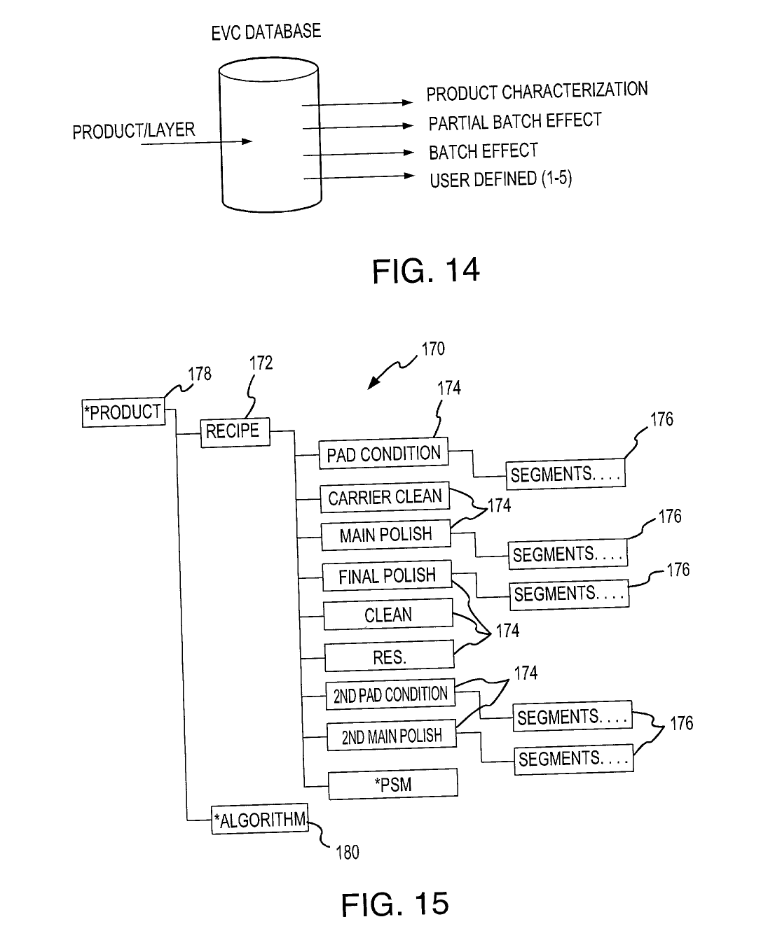

Many of the input parameters to the PSM are adjustable and definable by a user. The algorithms and algorithm file names are selectable by a user and the selection of which user parameters will be supplied to the computational engine are also user definable. The predefined variables that will be passed to the computational engine are the PCF, the PBEF and the BEF, as well as historical values such as Qual Rate, R2R factor and user defined factors. These values as well as other values are saved within a database based on individual product/layer combinations as shown in FIG. 14. Accordingly, a set of these values can be retrieved based on specifying the desired product/layer combination.

A product/layer hierarchy database is incorporated into the PSM of the present invention. The hierarchy is a logical linking of data and the linking is based on product/layer combinations which relate to the product and layer of material to be processed or polished. The product/layer hierarchy 170 contained within the product/layer hierarchy database of the PSM is shown in FIG. 15. Lower tiers of data are associated with upper links and a tree of data links has been extended to encompass an upper level of information. In current applications, a recipe 172 is linked to various processes 174, where each process is then linked to various segments 176. The new structure if the PSM has been extended to create a higher level in the tree structure. More specifically, the product/layer hierarchy 178 is an upper level which is linked to a recipe 172 and an algorithm 180. Accordingly, if a product/layer is chosen from the database, the recipe and algorithm are automatically chosen. This expansion of the hierarchy eases the burden on the user in that the user does not need to be knowledgeable of historical recipe data for each product/layer. As long as the user knows the which product/layer is to be polished, the tool automatically retrieves the linked data in the database. Once the database is populated, the user simply enters the product/layer information into the PSM and the tool automatically loads the associated data.

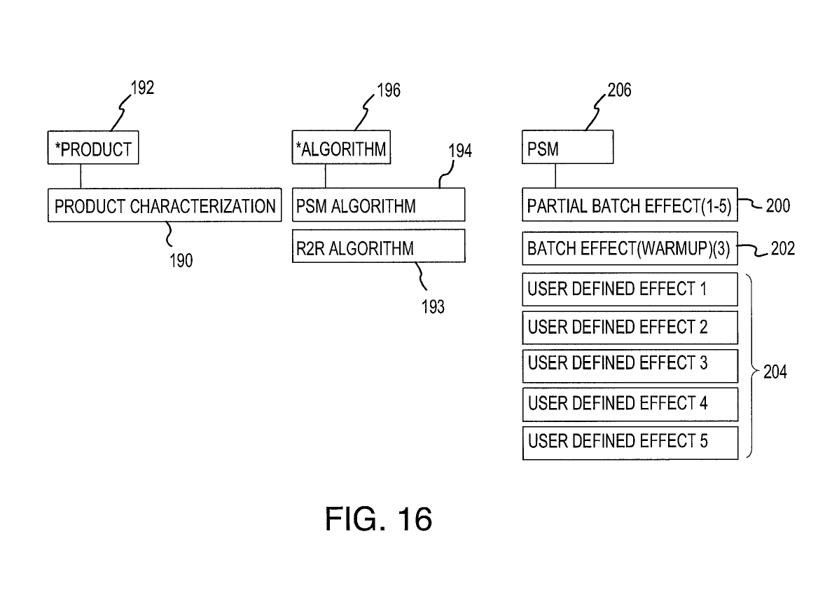

Each level in the hierarchy may contain stored data as well as links to other levels. The link locations of the PSM predefined variables are shown in FIG. 16. In other words, FIG. 16 shows which data is stored in each of the new levels that are added with the system and method of the present invention. Product characterization data 190 is stored within the product/layer level, predictive algorithm 194 and the R2R algorithm 193 are stored within the algorithm level 196, and partial batch effect 200, batch effect 202, and several user defined factors 204 are stored within the PSM level 206.

The PSM provides a graphical user interface (GUI) (not shown) to allow for easy creation of mathematical algorithms which can be stored in the PSM database. The GUI also provides a method for previewing the results returned from the computational engine before new values are actually accepted and used for processing wafers. The product/layer functionality of the PSM can be enabled or disabled in a configuration screen. If the PSM is disabled, no predictions of output variables are performed. The various parameters and screens associated with the PMS are invisible to the user if the PSM is disabled in order to avoid confusion as to the operating mode of the tool.

The PSM has a simulation mode, which can be enabled or disabled, where it can operate normally in performing computations. However, once the results are returned from the computational engine, the values are not automatically updated in the tool. This mode allows for the tool to continue operating as if the PSM system were not outputting computed process parameters but yet allows for the operation of the PSM to be evaluated. Therefore, the effectiveness and accuracy of the PSM can be monitored prior to enabling the PSM to update the tool with new variables for polishing batches of workpieces.

As previously mentioned, the alteration and creation of new product/layer combinations, or PSM or algorithm subsets of database records are tracked with a real-time tracking monitor. The real-time tracking monitor will trigger specific information, such as login name, date/time, and new versions to be updated to the version controlled database, upon making any alterations to the PSM system and method. This enables accountability for any changes that are made to the databases.

Each of the PSM predefined variables can be input into the computational engine by the MES, CIM, FA, process control framework, or the user. Each predefined variable has user configurable limits in order to reduce errors when inputting values. The limits define the upper and lower bounds of the coefficient and an error is generated if a value is entered that is outside of that range. If an error is generated, the value is not accepted for input. Monitoring the limits of such values aids in eliminating the chance of inputting invalid values which could be used to improperly calculate PSM outputs which could in turn destroy product. The limits will comprise different values for different product/layer combinations. The predefined variable limits for the PSM are stored in the hierarchy database along with the predefined variables for the PSM. If the limits for the predefined variables are modified, the version control system will detect the change and log a new version of the PSM. Modifications are also tracked and version tracking data is used to record user login name, date/time, structure modified and the new PSM version when modifications are made.

Upon loading a new batch of wafers into a tool, the tool will attempt to calculate predictive values. However, input parameters must be provided to the computational engine before predictive values can be calculated. Therefore, no calculations can be performed until the user provides input parameters. In order to eliminate the repetitive inputting of data and the delays associated with this task, the PSM includes an option to use previous values. Upon enabling the option to use previous values, the PSM retrieves the previously used input values and sends them to the computational engine after a new batch of workpieces has been loaded on the tool. The automatic loading of previous used values reduces the number of interactions between the MES, CIM, FA, process control framework or user, and the PSM, thereby reducing the overall cost of ownership of the system. This option of enabling the use of previously entered values can also be configured such that it only proceeds with certain pre-entered values.

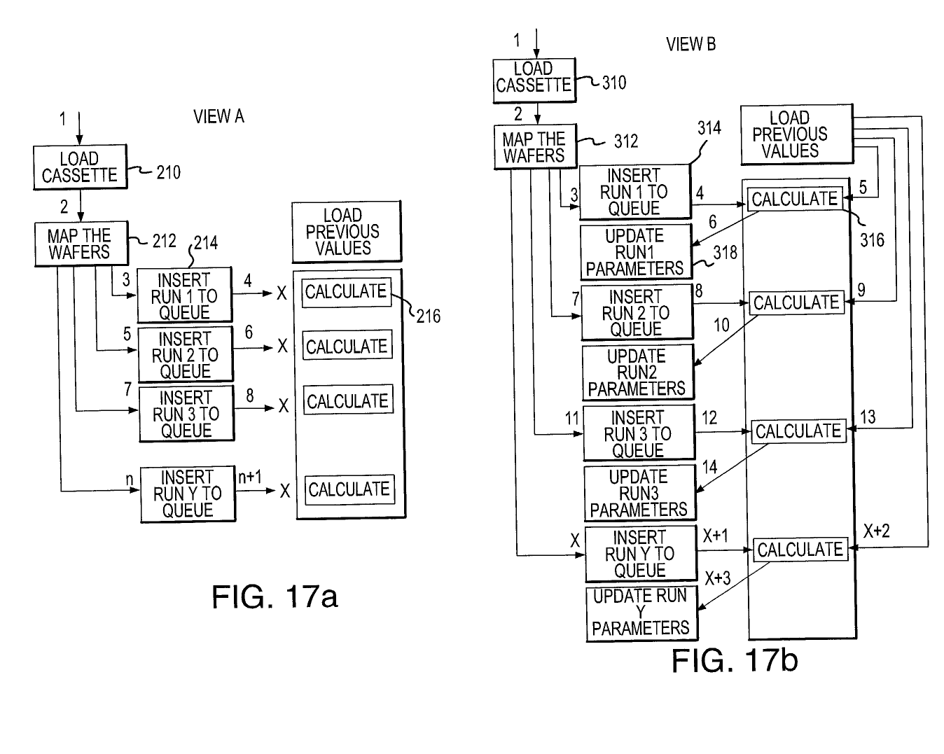

FIG. 17a shows the various steps in loading a batch of workpieces into a CMP tool with load previous values disabled. Workpieces are loaded into a cassette which comprises part of the CMP tool in step 210 and the workpieces are then mapped in step 212. Product/layer information along with input parameters are entered in step 214 and process parameters for the batch are calculated in the computational engine in step 216. This process is then repeated for different processing steps. FIG. 17b shows the various steps in loading a batch of workpieces into a CMP tool with load previous values enabled. Again, workpieces are loaded into a cassette in step 310 and the workpieces are then mapped in step 312. The use of previous values is indicated as being enabled in step 314 and sent to the computational engine. The actual previously used values are provided to the computational engine in step 316. The appropriate process parameters are then provided to process the workpieces in step 318.

The ability to use predefined parameters can be enabled or disabled with the present invention. If a parameter is enabled, the appropriate value for a given batch of workpieces is provided to the computational engine. If a user does not wish to use previous PSM parameters, the parameter is disabled.

A flowchart showing a method 400 for predicting software models to determine process parameters in accordance with the present invention is shown in FIG. 18. Polishing related variables are loaded into the system in step 410. In step 412, a determination is made as to whether the PSM of the present invention is enabled. If the PSM is not enabled, the polishing variables entered in step 410 are sent to the tool in step 414 for polishing. If the PSM is enabled in step 410, a determination is made as to whether a product/layer is input in step 416. If the product/layer information is input in step 416, the PSM parameters are loaded from the PSM database in step 418 and user mapped tool parameters are loaded in step 420. The parameters are then sent to the computational engine in step 422. Next, a determination is made in step 424 as to whether the PSM is in a simulation mode. If the PSM is in simulation mode, as previously discussed above, the polishing variables are sent to the tool in step 414 for polishing the workpieces. However, if the PSM is not in simulation mode in step 424, the results from the computational engine are loaded to the polishing variable in step 426 and the resulting polishing variable is sent to the tool in step 414 for polishing.

Turning back to step 416, if the product/layer information is not input at step 416, a determination is made as to whether the PSM has been enabled to use previous values at step 428. If the PSM has not been enabled to use previous values, the load parameters from step 410 are input in step 430 and user mapped tool parameters are loaded in step 420. Once again, parameters are sent to the computational engine in step 422 and a determination is made in step 424 as to whether the PSM is in simulation mode.

If the PSM is enabled to use previous values in step 428, the previous values are obtained and loaded in step 432. The parameters from the previous values are then loaded in step 430 which is followed by the loading of the user mapped tool parameters in step 420. The parameters are sent to the computational engine in step 422 and the process continues as described above depending upon whether or not the PSM is determined to be in simulation mode in step 424.

The system and method for predicting software models of the present invention has been described with particular reference to a system and method for predicting software models in the CMP of workpieces using material centric process instrumentation. Most of the key features of the present invention have been described above in detail. However, to further emphasize and point out the key features which distinguish the invention over the prior art, a list briefly summarizing those features follows.

Key features of the system and method for predicting software models of the present invention for the CMP of workpieces include:

1. A computational engine contained within the CMP tool in which a user can pass predictive software model (PSM) parameters and have the PSM return a calculated primary polishing time, as well as other process recipe parameters.

2. User defined algorithms where a user can define their own PSM algorithm to be used in determining polish time, downforce adjustments, pad conditioning time, inner diameter/outer diameter values, table rotation speeds, carrier oscillation speeds, carrier rotational speeds, coordinated position locations, and other process parameters. The algorithm can be defined off-line and then compiled and copied onto the computer's hard drive for use.

3. A standard algorithm that takes PSM parameters based on a specific tool's performance and computes polish time. A standard tool specific run-to-run algorithm can also be defined. The following two baseline equations can be modified by a user to suit their needs:

$${T}_{Pol} = \frac{( {T}_{Init} - {T}_{Tgt} )}{Q \times {F}_{R2R}} \times {F}_{a} \times {F}_{b} \times {F}_{c} \times …$$

$${F}_{R2R} = \frac{( {T}_{Init} - {T}_{Meas} )}{Q \times {T}_{Pol}} \times {F}_{a} \times {F}_{b} \times {F}_{c} \times …$$

where:

T_{Pol} is Process Recipe Polish Time

T_{Init} is Initial Incoming Thickness

T_{Tgt} is Target Final Thickness

T_{Meas} is Actual Measured Final Thickness

F_{R2R} is R2R Factor

Q is Qualification Removal Rate

Fₓ is Various Factors

4. Various user-definable PSM factors that can be sent as inputs to the computational engine and used to calculate polish time, downforce adjustments, pad conditioning time, inner diameter/outer diameter values, table rotation speeds, carrier oscillation speeds, carrier rotational speeds, coordinated position locations, and other process parameters

5. A software structure that provides for multiple parameters to be sent to the computational engine from the CMP tool.

6. A user definable algorithm for application within the computational engine where the algorithm is applied with the parameters that are passed to the computational engine to calculate the polish time.

7. A graphical user interface that allows for the algorithm to be input either directly or as a file name. A directly input algorithm is applied within the computational engine while an algorithm input as a filename uses a predefined file that is loaded onto the computer and passed to the input parameters to calculate polish time.

8. Current Qual Rate and R2R feedback adjustment values are maintained in the tool and are used as input parameters to the PSM computational engine.

9. Automatic Qualification Rate determination

10. Automatic maintenance of Tool Qualification State

11. A product characterization factor is implemented which adjusts polish time due to a variance in polish rates in comparison to a blanket wafer for each of the product/layer combinations.

12. A partial batch effect factor (PBEF) is characterized and implemented which adjusts polish time due to a variance in polish rates when less than five heads or carriers are used within one polish batch.

13. A PBEF characterized to have the option of a different value for each of the PSM processes to allow independent characterization of a different PBEF for each product/layer combination.

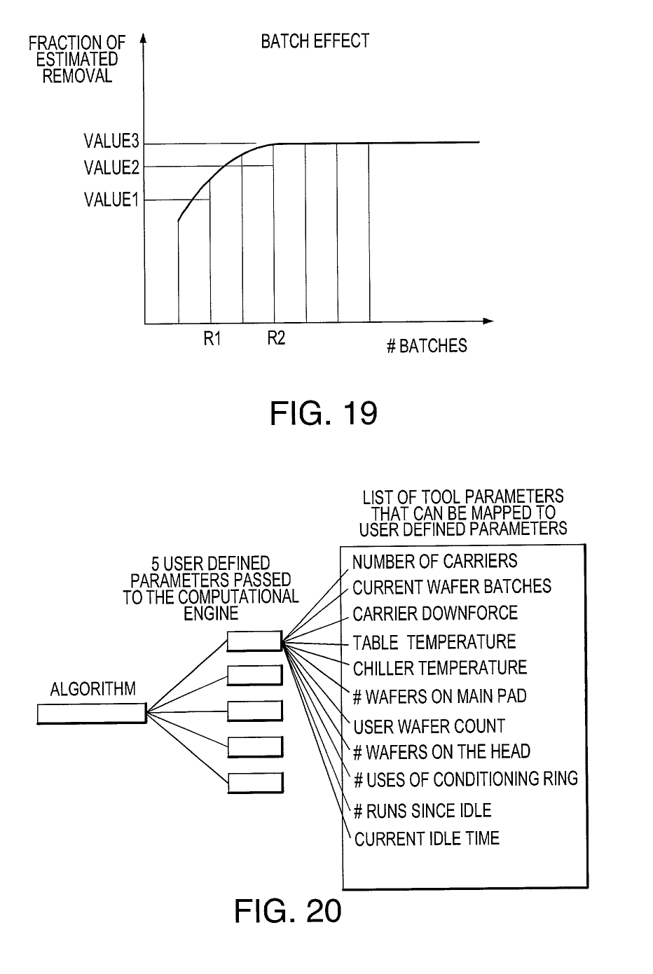

14. The characterization and implementation of a batch effect factor (BEF) which adjusts polish time due to a variance in polish rates when the CMP tool remains idle for a set amount of time. The effect is characterized in the PSM database by approximating the curve with three distinct values that are settable by a user. The point where the value transitions from one to the next (shown in FIG. 19 as R1 and R2) is set by transition batch numbers that are also configurable by a user.

15. The ability to disable use of the PBEF, BEF and product characterization parameters so that they are not used in the computational engine of the PSM.

16. The ability to supply various tool parameters to the computational engine which can be incorporated into an algorithm to influence the PSM outputs. The tool parameters can be mapped to user defined parameters as shown in FIG. 20 via the graphic user interface.

17. An integral PSM database that links various factors to product type to be polished. Providing a product/layer type automatically retrieves historically determined parameters to be used in predicting polish time including process recipes.

18. The ability to run one product/layer combinations consecutively without running test or dummy wafers between batches.

19. User definable PSM factor limits for detecting errors in inputting parameters into the PSM.

20. Batch level storage of PSM data for automatic retrieval and feed-back use to modify polish rates to compensate for natural drift in process (R2R factor).

21. PSM simulation mode for CMP tool where the tool proceeds to calculate a polish time and record the value for reference but polishes with the polish time provided by the user. Recorded values can be referenced at a later date to evaluate the validity of calculated times.

22. Optional storage and retrieval of previously used values for input into the computational engine to minimize user interaction for multiple batches of workpieces having the same material to be polished.

23. Input and storage of post-metrology data for correlation to values used in predicting polish times. A factor used to compensate for tool variations is derived from the correlation and adjusts the perceived Qual Rate to compensate for the natural polishing drift of the tool.

24. Configuration of software to automatically calculate a R2R factor when integrating an integrated in-line metrology unit into the CMP tool. The R2R factor is calculated sooner and increases the accuracy of the R2R factor.

25. Automatic optimization of product characterization factor.

The tool is configured to monitor consumables and input this information into the computational engine so that the consumables can be used to predict tool polishing behavior. This narrows the uncertainty of the natural tool drift parameters and more closely approximates the actual material removal. Data provided to the PSM is input via the GUI or downloaded from the MES, CIM, FA or process control framework. The majority of the software code is encompassed in the equipment virtual controller. The computational engine is the application MATHSUITE produced by Mathviews or a similar application. Historical data storage takes place in the SQL or similar database and the application INTOUCH produced by Wonderware, or a similar application, acts as the central distributor of data.

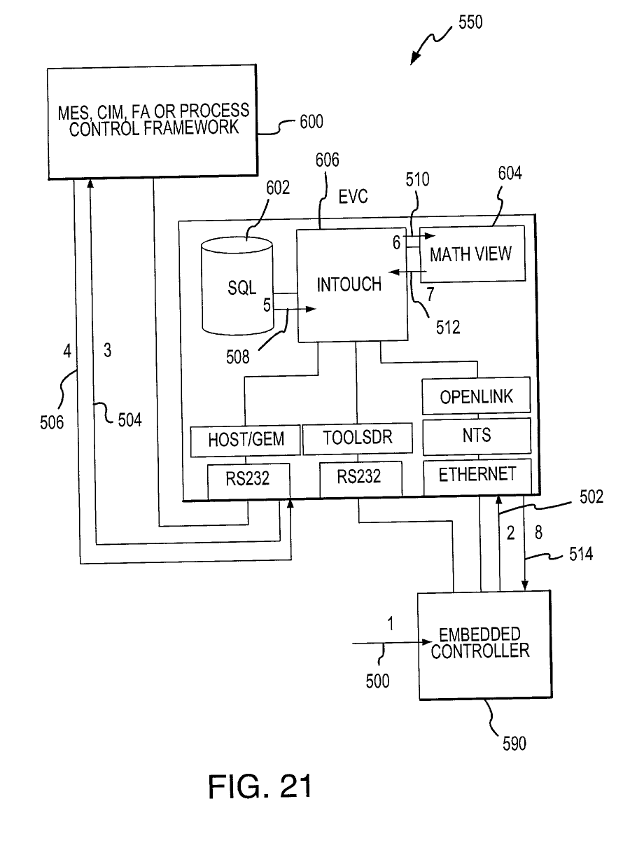

A block diagram 550 of the data paths and applications of the PSM in accordance with the present invention is shown in FIG. 21. A set of workpieces arrive at the tool 590 and are loaded on the tool 590 as signified by arrow 500. The data for the batch of wafers is transferred to the equipment virtual controller (EVC) as shown by arrow 502. The EVC then relays the data to the MES, CIM, FA or process control framework 600 as designated by arrow 504. The user then downloads the product/layer combination for the batch of wafers to be processed which is shown as arrow 506. The product/layer type is then used to retrieve the historical data from the database 602 as shown by arrow 508, since the characteristic data for every product/layer combination has previously been input into the PSM. The process recipe and PSM parameters from the database are loaded and the PSM parameters are input into the computational engine 604 as shown by arrow 510. The computational engine 604 then calculates the process parameters and returns them to the requesting application 606 (which here is a central distributor of data) as denoted by arrow 512. Finally, the process parameters are downloaded to the tool 590 as shown by arrow 514.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

We claim:

1. A system for predicting software models used in chemical mechanical polishing (CMP) of workpieces comprising:
a feed forward loop for computing predictive calculations;
a feed back loop for computing run-to-run calculations;
a historical database linking said feed forward and feedback loops wherein said calculations from said loops are archived with reference to a material identification; and
a computational engine used to calculate new or adjusted CMP process parameters.

2. The system of claim 1 wherein said material identification relates to at least one of a manufacturing execution system and a computer integrated manufacturing system.

3. The system of claim 1 wherein said feed forward and feedback loops create a distributed process control loop.

4. The system of claim 1 wherein each of said feed forward and feedback loops includes a logic component and a trigger component wherein data values passed in as input parameters to the logic component are used with at least one mathematical algorithm to calculate polish process parameters in the computational engine which are output from the trigger element.

5. The system of claim 4 wherein said input parameters for said feed forward loop include at least one of starting material thickness, target material thickness, removal rate, polishing pad characteristics, uniformity, Batch effect, Qual Rate, PSM algorithm, R2R algorithm, R2R factor, and product/layer characterization factor.

6. The system of claim 4 wherein said output parameters for said feed forward loop include at least one of polish time, pressure against wafer during polishing, polishing speed, carrier speed, carrier oscillation rate, carrier oscillation inner radii, carrier oscillation outer radii, slurry concentration, and slurry amount.

7. The system of claim 4 wherein the input parameters and mathematical algorithms used for making calculations within the system are controlled by a user.

8. The system of claim 7 wherein user changes to at least one of the input parameters and mathematical algorithms are tracked for accountability.

9. The system of claim 1 further comprising tracking of the archived data to determine alarm conditions or automatic parameter adjustments during polishing of the workpieces.

10. The system of claim 4 wherein said feedback loop updates the run-to-run calculation by adjusting process parameters to accommodate a natural drift in polishing characteristics of a CMP tool.

11. The system of claim 10 wherein said tool polishing characteristics include at least one of removal rate, uniformity, slurry characteristics, table temperatures, carrier temperatures, number of wafers processed, and pad characteristics.

12. The system of claim 2 wherein post CMP metrology data may be input directly into the historical database.

13. The system of claim 1 wherein process data for the CMP of workpieces is acquired directly from a CMP machine and passed to the computational engine.

14. A computer implemented method for predicting software models used in CMP of workpieces comprising the steps of:
inputting parameters to a logic component in a feed forward loop to compute predictive process parameter calculations;
archiving said calculated predictive process parameters in a historical database with reference to a material identification;
inputting post CMP metrology data to a logic component in a feedback loop to compute run-to-run process parameter calculations;
archiving the post CMP metrology data in the historical database with reference to a material identification;
linking the feed forward and feed back loops with the historical database; and
calculating new or adjusted CMP process parameters with a computational engine utilizing the archived data.

14. A method for automatically qualifying a CMP machine using a qualification rate comprising:
a) loading workpieces into the CMP machine;
b) determining whether the workpieces are a qualifying batch;
c) polishing the pieces;
d) measuring post CMP data of workpieces;
e) calculating a qualification rate;
f) determining if the qualification rate is within predetermined limits; and
g) adjusting a qualification state of the CMP machine if the qualification rate is within the predetermined limits.

15. The method of claim 14 further comprising the step of loading and polishing a new set of workpieces after adjusting the qualification state in step g.

16. The method of claim 15 further comprising the step of storing the qualification rate in a database located within the CMP machine.

17. The method of claim 16 further comprising the step of notifying the user and at least one of an MES, CIM, FA and process control framework if the calculated qualification rate is not within predetermined limits.

18. The method of claim 17 further comprising the step of adjusting the machine to return the machine to a qualified state.

19. The method of claim 14 further comprising the step of idling the CMP machine and classifying it as unqualified if the predetermined limits are not met.

20. A system for automatically qualifying a CMP tool using a qualification rate comprising:
means for loading workpieces in the CMP tool, means for determining whether said workpieces are a qualification batch;
means for measuring and storing workpiece data post CMP;
means for calculating a qualification rate based on post CMP data and determining if it is within predetermined limits; and
means for adjusting the CMP machine to accommodate the calculated qualification rate for polishing if in the predetermined limits or arresting polishing of said CMP machine is outside the predetermined limits.

21. A method for automatically optimizing product characteristics in a CMP machine for advanced process control comprising the steps of:
a) storing run-to-run factors for a specific product/layer in a database while operating the CMP machine;
b) obtaining a historical trend of said run-to-run factors after transition of the product/layer from said database and sampling said trend to determine if there is a skewing of data; and
c) analyzing a magnitude of error; and
d) calculating a product characterization factor for the product/layer if the pattern of error is consistently in the same magnitude and direction after the transition.

22. The method of claim 21 further comprising the step of saving the calculated product characterization factor to the database.

23. The method of claim 21 further comprising the step of triggering data logging to a version control system.

24. The method of claim 23 wherein said data includes at least one of user login name, date, time, product characterization factor values, and identification of product/layer.

25. The method of claim 22 wherein steps a through d are periodically initiated by a user.

26. The method of claim 23 further comprising the step of relaying said data to at least one of the MES, CIM, FA or process control framework.
